(19) United States
(12) Patent Application Publication
(10) Pub. No.: US 2024/0371104 A1
(43) Pub. Date: Nov. 7, 2024

(54) INTERACTIVE VIEWING OF DAMAGE TO AN OBJECT

(71) Applicant: CCC Intelligent Solutions Inc., Chicago, IL (US)

(72) Inventors: Atman Kilewala, Chicago, IL (US); Arjun Punjabi, Chicago, IL (US); Surendran Narayanamoorthy, Aurora, IL (US)

(21) Appl. No.: 18/231,480

(22) Filed: Aug. 8, 2023

Related U.S. Application Data
(60) Provisional application No. 63/464,070, filed on May 4, 2023.

(51) Int. Cl. G06T 19/00; G06F 3/01; G06F 3/16; G06T 17/00

(52) U.S. Cl. CPC G06T 19/006; G06F 3/017; G06F 3/167; G06T 17/00; G06T 2219/004; G06T 2219/024; G06T 2219/028

(57) ABSTRACT

An augmented reality or virtual reality system is used to evaluate damage to an object. The first user may wear the ar/vr headset and the second party may be able to view the object just as the first user. The first and second user may be able to communicate through the ar/vr system. Both users may be able to augment and manipulate the images being seen in the ar.vr system. As a result, more detailed images and descriptions of damage to an object that are valuable and useful to a second party maf410y be obtained in less time with improved accuracy

### CROSS-REFERENCE TO RELATED APPLICATIONS

This application claims priority to U.S. Provisional Application No. 63/464,070, filed May 4, 2023, the disclosure of which is incorporated by reference herein in its entirety.

### BACKGROUND

Current methods and systems of evaluating damage to an object like a vehicle have many drawbacks. In many instances, one party may use a camera to create two dimensional images and communicate the images to a second party to evaluate. The second party may require more information about the images and the first party may have to return to the object to obtain the additional images at a later time.

In some advanced methods and systems, the images may be stored and the stored images may be annotated using an animation application at a later time. Not all the desired views of the object may be available and some desired annotations may not be possible.

Finally, the images are in two dimensions. If additional angles are needed, then additional images may need to be obtained. The images cannot be manipulated such as turned or rotated.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

An augmented reality (ar) or virtual reality (vr) system is used to evaluate damage to an object. The first user may wear the ar/vr headset and the second party may be able to view the object through the ar/vr view of the first user. The first and second user may be able to communicate through the ar/vr system. Both users may be able to augment and manipulate the images being seen in the ar/vr system. The images may be a single image, a plurality of images or a video and the images may be in two or three dimensions.

In some embodiments, the ar/vr system may create a three dimensional image of the object. The three dimensional image may be rotated, expanded, focused and augmented by the user. As a result, more detailed images and descriptions of damage to an object that are valuable and useful to a second party may be obtained in less time with improved accuracy.

### BRIEF DESCRIPTION OF THE DRAWINGS

FIG. 1 may illustrate blocks performed by a processor according to a method in accordance with the claims;

FIGS. 2a and 2b may be illustration of headsets;

FIG. 3 may illustrate a headset 200 being used to examine an object wherein the headset 200 is in communication with computing devices of other users;

FIG. 4 may illustrate a sample display to a user of options available;

FIG. 5 may illustrate a sample object being rotated in the display;

FIG. 6 may illustrate a sample computing device in accordance with the claims; and

FIG. 7 may illustrate an example of augmented reality.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is an exemplification and is not intended to be limited to any one of the embodiments illustrated. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

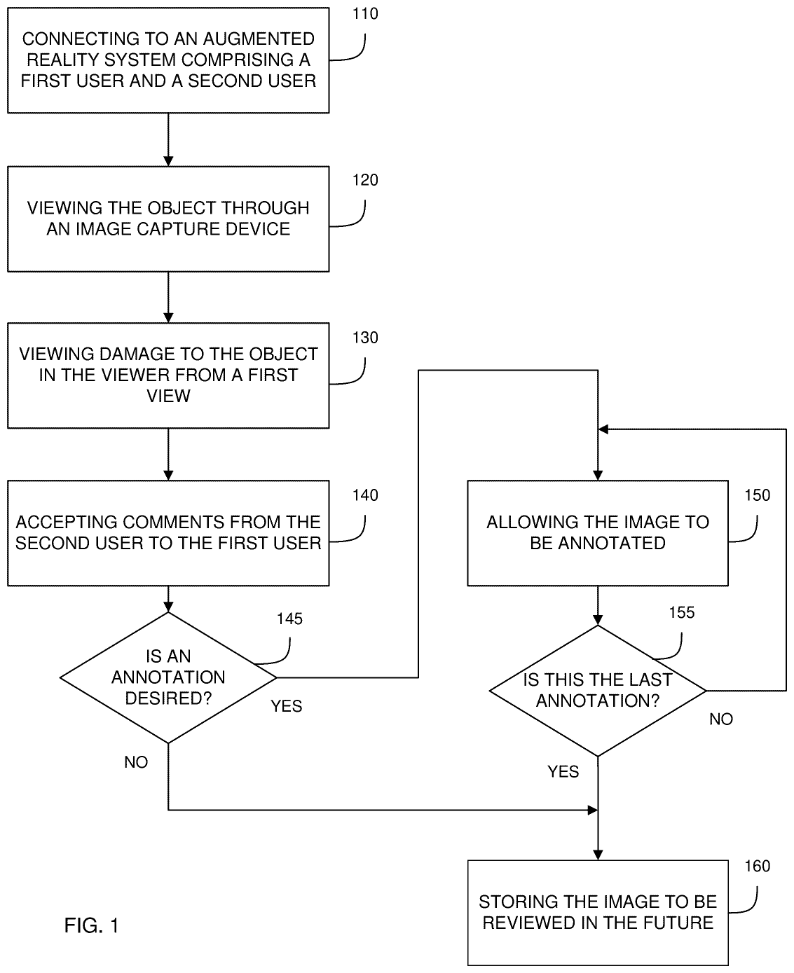

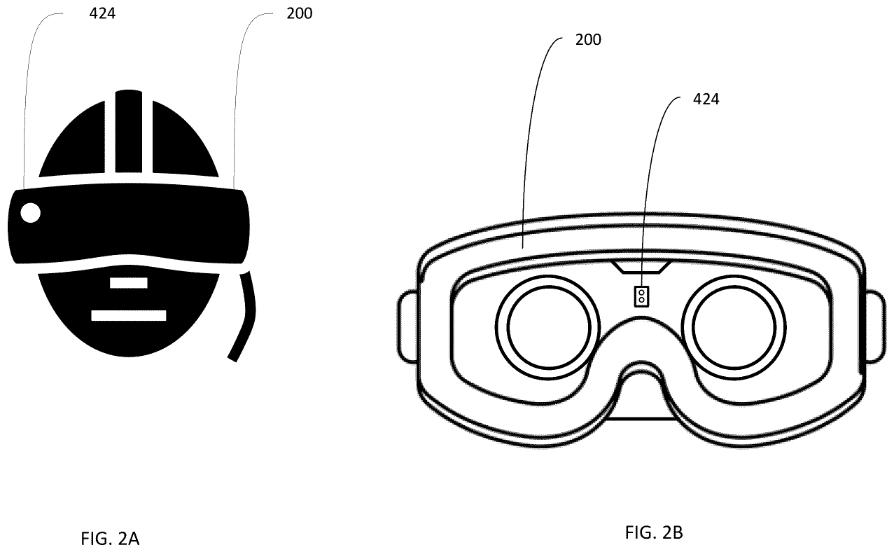

Referring now to FIG. 1, a method of using augmented reality to assess damage to an object 301 may be described. The object 301 may be any object 301 such as a vehicle, a house or another piece of property. At block 110, an augmented or reality viewer may connect to an augmented reality system. The viewer may be any augmented reality or virtual reality headset 200 such as the Oculus from Meta or the Hololens system from Microsoft as illustrated in FIG. 2. In some embodiments, a smart phone may be used as the viewer. The smart phone may be installed in a headset 200 or may be hand held in a traditional manner.

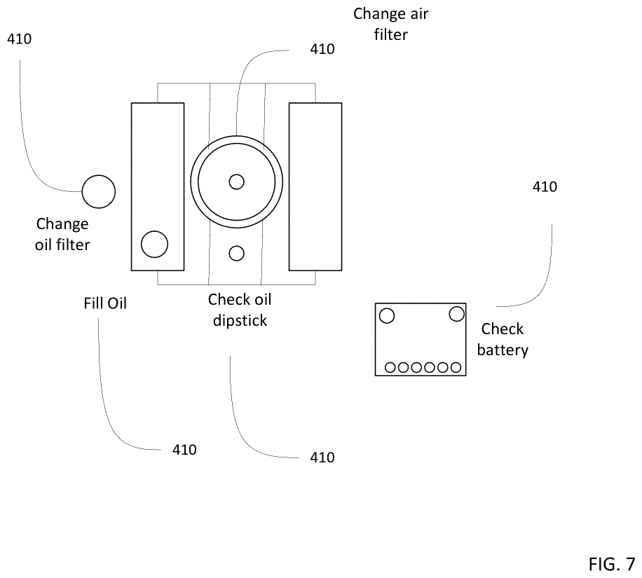

At a high level, an augmented reality system provides a view of reality with augmentations. For example, the augmented reality system may show a group of trees and each tree may be labeled or augmented with the type of tree. The trees viewed may be real and the labels may be added by the system. Similarly, while looking at a car engine, the various part of the car may exist in reality and names may be added to the car parts. FIG. 7 may illustrate a car engine with specific parts labeled using identification codes.

A virtually reality system may be a computer generated image that may or may not reflect reality. The images may be a single image, a plurality of images or a video and the images may be in two or three dimensions. For example, the viewer may show an image of computer generated trees and the trees may be labels with the type of tree. Similarly, a car engine may be created graphically and the parts may be labeled with computer generated labels. In addition, the virtual reality system may be an entirely unreal environment such as a space craft flying landing on an unknown planet.

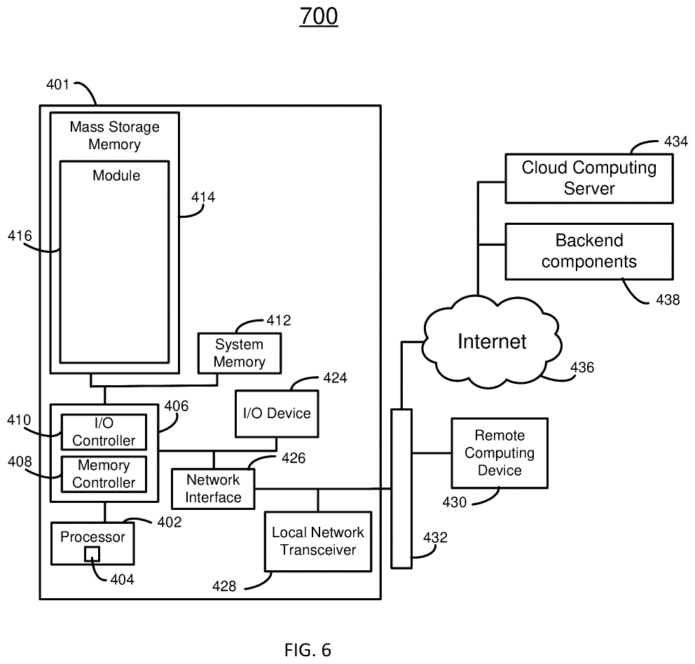

The system may include a headset 200 such as illustrated in FIG. 2. Briefly referring to FIG. 6, the headset 200 may have a processor which may be in communication with an input/output circuit and a memory. A display element may be used to display images to a user inside the headset. The headset 200 also may have a sound element which may capture sounds around the user and may also play sounds to the user through the headset. The headset 200 also may have an image sensor which may intake images in front of the headset. In some embodiments, image sensors 424 may be used to track eye movements to change the view of the user based on the movement of the eyes. The headset 200 may also include a wireless communication element which may communicate with a receiver which may be a wireless router or another computer or may be a Bluetooth receiver. Of course, other types of wireless communication systems are contemplated and are included. The system may be specifically designed to provide smooth video to the user which may require extensive video processing capabilities.

The system may allow additional users 303 to be part of the system at the same time. For example, one user 303 may be walking through a forest and a second user may be in a tree watching the first user. The two users 303 may make waiving movements toward each other in real life and the waiving activity may be illustrated in the viewer. Similarly, the two users may speak to each other similar to a phone conversation with many users.

Referring again to FIG. 1, at block 120, the object 301 may be viewed through an image capture device 424. In some embodiments, the object 301 may be a vehicle such as a car. In other embodiments, the object 301 may be a building, a boat or any other object 301 of value.

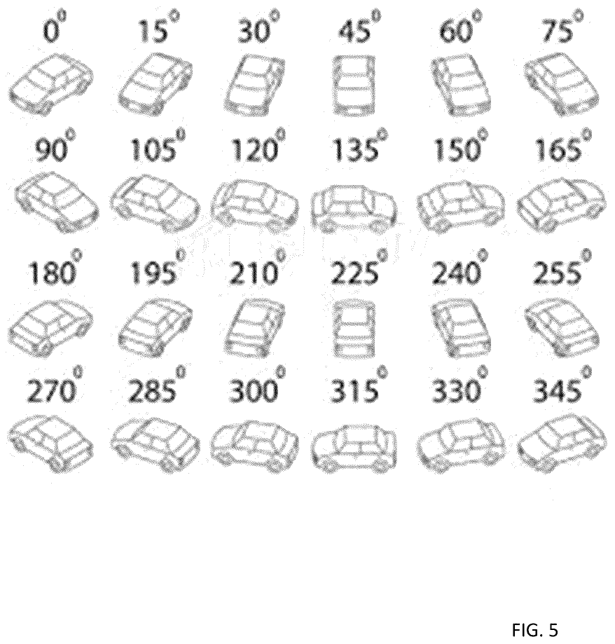

In some embodiments, a 3-d model of the object 301 may be created such as in FIG. 5. Software such as from Adobe, SelfCAD, 3DSOM, Autodesk Tinkercad, Vectary, Blender or Photomodeler are just some examples of software that may be used to create a 3D model from input from an image device. The 3-d model may be a type of image and may be able to be manipulated by a user to be rotated in all three dimensions such that it may be seen from virtually endless perspectives as illustrated in FIG. 5. The images may be a single image, a plurality of images or a video. In addition, internal damage may be model and estimated.

Artificial intelligence and machine learning may be used to improve the process of estimating the damage to the internal aspects of the object. For example, past damages to a specific vehicle may be analyzed by artificial intelligence or machine learning systems and the resulting trained model may be used to predict internal damage based on observed damage to the exterior of the vehicle.

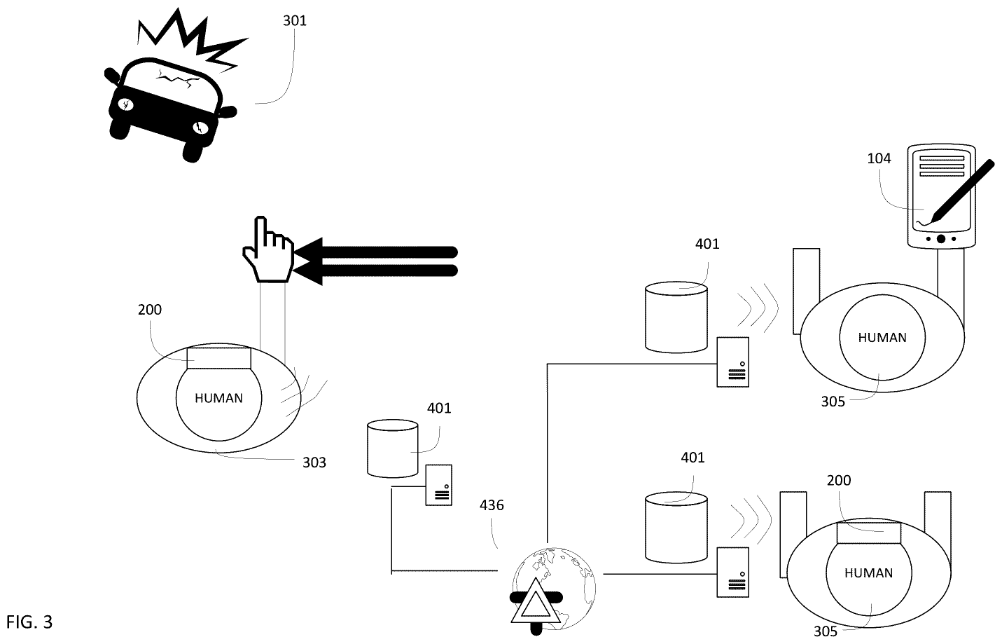

Referring to FIG. 1 again, at block 130, damage to the object 301 may be viewed in the viewer from a first view. FIG. 3 may illustrate a user 303 looking at an object 301 which may be a damaged vehicle. For example, the object 301 may be viewed from the front of the object 301. Of course, the first view could be any angle of the object 301. In some embodiments as will be explained, the object 301 may be viewed from a plurality of angles to better assess the damage to the object 301 or to ensure all the damage is captured.

At block 140, comments from the second user 305 to the first user may be accepted. There may only be one user 303 wherein no comments may be received or there may be many users and many comments may be received. Logically, comments may be useful in directing the first user to focus or direct attention to certain aspect of the damaged object 301. The comments may be used to determine more detail on the object 301 and any damage thereto. For example, the second user may request the first user to open the hood on a vehicle to determine if there is any internal damage to the engine of the vehicle. As all the users 303 305 are in electronic communication, the desired information for all the users 303 305 may be gathered at one time and an electronic record may be created which may be reviewed later. For example, the second user 305 may interested in the inside of the vehicle 301 and the first user 303 may direct the view image sensor 424 from the headset 200 into the interior of the car.

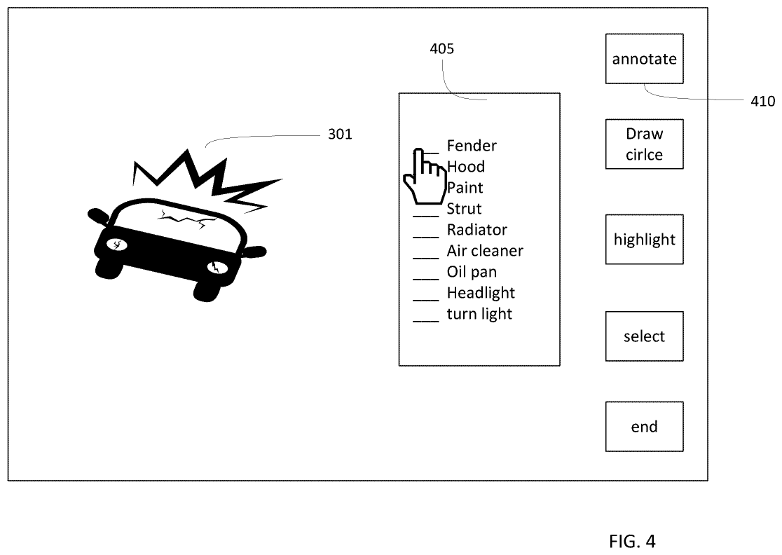

At block 145, the method may determine if an annotation 410 is desired. As illustrated in FIG. 4, a user 303 may see an object 301 and may be presented with the option to annotate the image. As mentioned previously, the image may be a single image, a plurality of images or a video and the images may be in two or three dimensions. In addition, the user 303 may be presented a list of items 405 that may need to be fixed or replace on the object 301 which may assist in damage estimates. If no annotations 410 are indicated, the method may move to block 160. If further annotations 410 are indicated, in some embodiments, the user may select to annotate 410 the image by making a hand motion to select to annotate the image. In other embodiments, the user 303 may use voice commands to indicate an annotation 410 is desired. In yet another embodiment, a head motion or eye motion may indicate an annotation 410 is desired. In another embodiment, a physical button on the headset 200 may indicate an annotation 410 is desired. Of course, other method of indicating an annotation 410 is desired are possible and are contemplated.

At block 150, the image may be annotated. The annotations 410 may be useful to highlight damage to the object 301. For example, a scratch to a finish may be difficult to see from certain image capture devices or in certain lighting but my be relevant to the users. The scratch may be annotated to the image from the image capture device 424. It should be noted the image may be a single image, a plurality of images or a video of the object, all of which may be annotated as appropriate.

The annotation 410 may occur in a variety of ways. In some embodiments, the first or second user may simply draw on a touch screen such as the touch screen of a smart phone using a software application such as MS Paint or Photoshop from Adobe. If the device is an AR or VR device, any of the users 303 305 may user hand gestures to select to annotate the image and may then use hand gestures to annotate the image. For example, a user 303 305 may circle the scratch on the object 301 that may be difficult to see due to various lighting conditions and the user may use a hand gesture to circle the scratch on the object 301. In yet some additional embodiments, voice commands may be used to annotate the image. For example, either of the users 303 305 may say “system, draw a circle” and a circle may appear on the image. The users 303 305 may then direct the placement and size of the circle using voice commands. In yet another embodiment, the system 401 may track the head movements or eye movements of either of the user 303 305 and the eye movements may be used to select and highlight objects 301 in the images. Logically, the highlights can take on virtually any form such as circles, highlights, text, numbers, measurements, etc.

In some embodiments, the annotation 410 are completed by the first user 303 who may receive directions from the second user 305. In some other embodiments, the second user 305 may be able to add annotations 410 themselves. Logically, there may be additional users 305 and the users 305 are not necessarily human but may be software routines or hardware elements automated to assist in the analysis of vehicle review.

In yet another aspect, the system 401 and method (FIG. 1) may use object anchoring to annotate the image. In object anchoring, an object 301 may be identified. For example, an object 301 may be identified as a specific type of car such as a 1994 Toyota Corolla (Corolla). The system 401 and method (FIG. 1) may then retrieve data on the object (Corolla) 301 such as a 3-D wireframe image of the object (Corolla) or an set of annotations that label the items under the hood of the Corolla. The data may then be overlaid on the image of the object 301. In the Corolla example, the wireframe of the Corolla may be overlaid on the image of the physical Corolla in the image viewer. As has been mentioned previously, the images may be a single image, a plurality of images or a video and the images may be in two or three dimensions.

In some instances, the data may need to be manipulated by the system 401 and method (FIG. 1) to properly fit on the object 301 as there may be differences in size or in the angle of viewing the object 301. The method may properly adjust the data to fit the object 301 such that the data is applied in an appropriate manner to the object. In the wireframe example, the wireframe may be re-sized to match the object in view. Once the adjustments have been made, the overlay may be “anchored” to the image and further movements of the image will result in the augmentations following the movement of the image. The images may be a single image, a plurality of images or a video and the images may be in two or three dimensions. Either special anchoring (hard coding to a location) or object anchoring (more flexible application to entire objects) may be used.

Referring to FIG. 7, the size of the label overlay may be adjusted by the system 401 and method (FIG. 1) to fit the items under the hood as it would not be logical to have labels applied to areas outside the object. As a result, items in images of objects may be quickly identified once the overlays are appropriately applied. Using the wireframes as an example, changes to the body a vehicle as the result of an accident may be easily seen. Similarly, augmentations to the engine items may make it clear what items may have been damages and may need to be replaced.

There may be more than one data set anchored on an object 301. For example, wireframe and the identification of parts may be overlaid on the same vehicle. The data may be applied in layers and each layer may be anchored to the object. The layers may be changed to have different layers “on top” or other layers hidden depending on the purpose of the analysis. For example, a body shop may not care that the alternator is indicated on a car image while a mechanic may not care that a quarter panel is out of alignment.

At block 155 in FIG. 1, the method may determine if additional annotations 410 are desired. If no further annotations 410 are indicated, the method may move to block 160. If further annotations 410 are indicated, in some embodiments, the user 303 may select to further annotate the image by making a hand motion to select to annotate the image. In other embodiments, the user 303 may use voice commands to indicate a further annotation is desired. In yet another embodiment, a head motion or eye motion may indicate a further annotation is desired. In another embodiment, a physical button on the headset 200 may indicate a further annotation is desired. Of course, other method of indicating a further annotation is desired are possible and are contemplated.

At block 160, the annotation 410 may be stored along with the augmented video to be view by additional parties. The video or images may be used for a variety of purposes and a variety of people. In some embodiments, the images may be reviewed to determine the value of the damages to the object 301. In some additional embodiments, images may be viewed to determine whether a person may have been injured by the damage and to what extent. For example, the images may be of a vehicle and the images may indicate an air bag went off which may indicate a serious accident and possible injuries to a person.

In some embodiments, the images may also be reviewed to assist in determining fault in an accident. The damage to the object 301 may be compared to the description to determine if the damage to the object 301 matches the description.

In some embodiments, the images may be analyzed by a human and in other embodiments, the images may be reviewed by a software application. The software application may be specifically designed using artificial intelligence/machine learning to determine damage to the object 301 or injuries to a person. The software may also determine the value to fix the object 301 and whether the object 301 should be determined to be a total loss or whether it makes economic sense to fix the object 301.

In some embodiments, the image file may be communicated to a user computing device or display 200 where it may be stored and viewed. The electronic image file may be communicated using a known protocol for accuracy, efficiency and security reasons. In some additional embodiments, the image file may be communicated to a web portal and a known protocol may be used. The electronic image file may accessed using an API. In some embodiments, the image file may be stored using encryption to ensure it is not copied.

FIG. 6 is a high-level block diagram of an example computing environment 400 for the system 100 and methods (e.g., method in FIG. 1) as described herein. The computing device 400 may include a server, a mobile computing device, a cellular phone, a tablet computer, an electronic reader, a virtual reality headset, an artificial reality headset, a Wi-Fi-enabled device or other personal computing device capable of wireless or wired communication, a thin client, or other known type of computing device (e.g., a mobile computing device 104, a merchant computer system 106, a payment network system 108 and a payment device issuer system 111, etc.). Logically, the computing device 400 may be designed and built to specifically execute certain tasks.

As will be recognized by one skilled in the art, in light of the disclosure and teachings herein, other types of computing devices can be used that have different architectures. Processor systems similar or identical to the example systems and methods described herein may be used to implement and execute the example systems and methods described herein. Although the example system 400 is described below as including a plurality of peripherals, interfaces, chips, memories, etc., one or more of those elements may be omitted from other example processor systems used to implement and execute the example systems and methods. Also, other components may be added.

As shown in FIG. 6, the computing device 401 may include a processor 402 that is coupled to an interconnection bus. The processor 402 may include a register set or register space 404, which is depicted in FIG. 6 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 6, the computing device 401 may be a multi-processor device and, thus, may include one or more additional processors that are identical or similar to the processor 402 and that are communicatively coupled to the interconnection bus.

The processor 402 of FIG. 6 may be coupled to a chipset 406, which includes a memory controller 408 and a peripheral input/output (I/O) controller 410. As is well known, a chipset may typically provide I/O and memory management functions as well as a plurality of general purpose and/or special purpose registers, timers, etc. that are accessible or used by one or more processors coupled to the chipset 406. The memory controller 408 may perform functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, the computing device 401 may be used to implement a module 416 (e.g., the various modules as herein described). The mass storage memory 414 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401, the systems and methods described herein. Thus, a module, block, function, operation, procedure, routine, step, and method can be implemented in hardware, firmware, and/or software.

In one embodiment, program modules and routines may be stored in mass storage memory 414, loaded into system memory 412, and executed by a processor 402 or may be provided from computer program products that are stored in tangible computer-readable storage mediums (e.g. RAM, hard disk, optical/magnetic media, etc.).

The peripheral I/O controller 410 may perform functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the module 416, etc., to receive data from the transceiver 428, send the data to the components of the system 100, and perform any operations related to the methods as described herein. The local network transceiver 428 may include support for a Wi-Fi network, Bluetooth, Infrared, cellular, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 6 as separate functional blocks within the chipset 406, the functions performed by these blocks may be integrated within a single integrated circuit or may be implemented using two or more separate integrated circuits. The computing environment 400 may also implement the module 416 on a remote computing device 430. The remote computing device 430 may communicate with the computing device 401 over an Ethernet link 432. In some embodiments, the module 416 may be retrieved by the computing device 401 from a cloud computing server 434 via the Internet 436. When using the cloud computing server 434, the retrieved module 416 may be programmatically linked with the computing device 401. The module 416 may be a collection of various software playgrounds including artificial intelligence software and document creation software or may also be a Java® applet executing within a Java® Virtual Machine (JVM) environment resident in the computing device 401 or the remote computing device 430. The module 416 may also be a “plug-in” adapted to execute in a web-browser located on the computing devices 401 and 430. In some embodiments, the module 416 may communicate with back end components 438 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 6 to simplify and clarify the description, it is understood that any number of client computers may be supported and may be in communication within the system 400.

Additionally, certain embodiments may be described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” may be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” may refer to a hardware module. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, may be merely convenient labels and are to be associated with appropriate physical quantities.

Unless specifically stated otherwise, discussions herein using words such as “processing,” “computing,” “calculating,” “determining.” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” may mean that a particular element, feature, structure, or characteristic described in connection with the embodiment is included in at least one embodiment. The appearances of the phrase “in some embodiments” or “teachings” in various places in the specification may not necessarily all be referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments may not be limited in this context.

Further, the figures depict preferred embodiments for purposes of illustration only. One skilled in the art may be readily recognize from the following discussion that alternative embodiments of the structures and methods illustrated herein may be employed without departing from the principles described herein.

Upon reading this disclosure, those of skill in the art may appreciate still additional alternative structural and functional designs for the systems and methods described herein through the disclosed principles herein. Thus, while particular embodiments and applications have been illustrated and described, it is to be understood that the disclosed embodiments may not be limited to the precise construction and components disclosed herein. Various modifications, changes and variations, which may be apparent to those skilled in the art, may be made in the arrangement, operation and details of the systems and methods disclosed herein without departing from the spirit and scope defined in any appended claims.

1. A method of using augmented reality to assess damage to an object comprising:
connecting to an augmented reality system comprising a first user and a second user;
viewing the object through an image capture device;
viewing damage to the object in the viewer from a first view;
accepting comments from the second user to the first user;
determining if an annotation is desired;
in response to determining an annotation is desired:
allowing the image to be annotated;
storing the annotation along with augmented video to be view by additional parties.

2. The method of claim 1, further comprising estimate loss based on the augmented video.

3. The method of claim 1, further comprising creating 3-d model of the object.

4. The method of claim 1, further comprising highlight damages to the object.

5. The method of claim 1, further comprising:
determining if additional annotations are desired;
in response to determining an additional annotation is desired:
allowing the image to be further annotated.

6. The method of claim 1, wherein annotations are created by moving a hand.

7. The method of claim 1, wherein annotations are created by voice command.

8. The method of claim 1, further comprising allowing the view to be changed to a second view.

9. A non-transitory computer readable medium comprising computer executable instructions that physically configure a processor, the computer executable instruction comprising instructions for using augmented reality to assess damage to an object comprising instruction for:
connecting to an augmented reality system comprising a first user and a second user;
viewing the object through an image capture device;
viewing damage to the object in the viewer from a first view;
accepting comments from the second user to the first user;
determining if an annotation is desired;
in response to determining an annotation is desired:
allowing the image to be annotated;
storing the annotation along with augmented video to be view by additional parties.

10. The non-transitory computer readable medium of claim 9, further comprising estimate loss based on the augmented video.

11. The non-transitory computer readable medium of claim 9, further comprising creating 3-d model of the object.

12. The non-transitory computer readable medium of claim 9, further comprising highlight damages to the object.

13. The non-transitory computer readable medium of claim 9, further comprising:
determining if additional annotations are desired;
in response to determining an additional annotation is desired:
allowing the image to be further annotated.

14. The non-transitory computer readable medium of claim 9, wherein annotations are created by moving a hand.

15. The non-transitory computer readable medium of claim 9, wherein annotations are created by voice command.

16. The non-transitory computer readable medium of claim 9, further comprising allowing the view to be changed to a second view.

17. A computer system comprising:
a processor that is physically configured according to computer executable instructions,
a memory in communication with the processor; and
an input-output circuit in communication with the processor,
the computer executable instruction comprising instructions for using augmented reality to assess damage to an object comprising:
connecting to an augmented reality system comprising a first user and a second user;
viewing the object through an image capture device;
viewing damage to the object in the viewer from a first view;
accepting comments from the second user to the first user;
determining if an annotation is desired;
in response to determining an annotation is desired:
allowing the image to be annotated;
storing the annotation along with augmented video to be view by additional parties.

18. The computer system of claim 17, further comprising estimate loss based on the augmented video.

19. The computer system of claim 17, further comprising creating 3-d model of the object and highlighting damages to the object.

20. The computer system of claim 17, further comprising:
determining if additional annotations are desired;
in response to determining an additional annotation is desired:
allowing the image to be further annotated.
